(19) United States
(12) Patent Application Publication
(10) Pub. No.: US 2026/0139584 A1
(43) Pub. Date: May 21, 2026

(54) SYSTEMS AND METHODS FOR ACQUIRING ELECTROMAGNETIC MEASUREMENTS WHILE DRILLING

(71) Applicant: Schlumberger Technology Corporation, Sugar Land, TX (US)

(72) Inventor: Mark Frey, Sugar Land (TX)

(21) Appl. No.: 19/289,463

(22) Filed: Aug. 4, 2025

Related U.S. Application Data
(60) Provisional application No. 63/721,310, filed on Nov. 15, 2024.

(51) Int. Cl. E21B 49/00; E21B 44/00; G01V 3/28

(52) U.S. Cl. CPC E21B 49/00; E21B 44/00; G01V 3/28

(57) ABSTRACT

A system includes a drilling system. The drilling system includes a tool string, a bottom hole assembly coupled to a downhole end of the tool string, and a plurality of sensors disposed along the tool string and the bottom hole assembly. The plurality of sensors includes a first sensor disposed proximate to a drill bit of the tool string. The first sensor includes a first transmitter or a first receiver. The plurality of sensors also includes a plurality of second sensors axially offset away from the first sensor further away from the drill bit. The first sensor is configured to communicate with at least a portion of the plurality of second sensors, and the plurality of second sensors includes a nested arrangement of second transmitters and second receivers.

### CROSS REFERENCE TO RELATED APPLICATION

The present application claims priority to and benefit of U.S. Provisional Patent Application No. 63/721,310, titled, “SYSTEMS AND METHODS FOR ACQUIRING ELECTROMAGNETIC MEASUREMENTS WHILE DRILLING,” filed on Nov. 15, 2024, which is incorporated herein by reference in its entirety.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Sometimes, during a drilling operation, one or more sensors may be deployed in a wellbore for determining one or more characteristics of a surrounding formation. These sensors may include one or more transmitters disposed on a drill string that emit an electromagnetic signal to one or more receivers disposed on the drill string. Low sensitivity and high spreading loss of the electromagnetic signal may occur due to the spacing of the one or more transmitters and/or one or more receivers along the drill string. Accordingly, it may be desirable to develop techniques for increasing the sensitivity of the sensors to the surrounding formation while concurrently decreasing the spreading loss of the signal.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In certain embodiments, a system includes a drilling system. The drilling system includes a tool string, a bottom hole assembly coupled to a downhole end of the tool string, and a plurality of sensors disposed along the tool string and the bottom hole assembly. The plurality of sensors includes a first sensor disposed proximate to a drill bit of the tool string. The first sensor includes a first transmitter or a first receiver. The plurality of sensors also includes a plurality of second sensors axially offset away from the first sensor further away from the drill bit. The first sensor is configured to communicate with at least a portion of the plurality of second sensors, and the plurality of second sensors includes a nested arrangement of second transmitters and second receivers. The drilling system also includes a controller having a memory and a processor. The controller is configured to receive a plurality of signals from the first sensor or the plurality of second sensors. The controller is also configured to combine the plurality of signals to compensate a transmitter gain and a receiver gain of at least some sensors of the plurality of sensors.

In certain embodiments, a system includes a measurement system including a plurality of sensors configured to couple to a drill string. The plurality of sensors includes a first sensor including a first transmitter, and a plurality of second sensors axially offset away from the first sensor. The plurality of second sensors includes a nested arrangement of receivers and second transmitters. The system also includes a controller having a processor, a memory, and instructions stored on the memory and executable by the processor to transmit signals from the first transmitter to each of the receivers in the nested arrangement. The instructions also cause the processor to transmit signals from the second transmitters to each of the receivers. The instructions also cause the processor to receive a plurality of signals from the first sensor or the plurality of second sensors. The instructions also cause the processor to combine the plurality of signals to compensate a transmitter gain and a receiver gain of at least some sensors of the plurality of sensors.

In certain embodiments, a method, includes deploying a measurement system including a plurality of sensors into a wellbore via a drill string. The plurality of sensors includes a first sensor having a first transmitter and a plurality of second sensors axially offset away from the first sensor. The plurality of second sensors includes a nested arrangement of receivers and second transmitters. The method also includes transmitting signals from the first transmitter to each of the receivers in the nested arrangement. The method also includes transmitting signals from the second transmitters to each of the receivers. The method also includes receiving a plurality of signals from the first sensor or the plurality of second sensors. The method also includes combining the plurality of signals to compensate a transmitter gain and a receiver gain of at least some sensors of the plurality of sensors. The method also includes obtaining measurements of a geological formation based on the signals, the compensated transmitter gain, the compensated receiver gain, or a combination thereof. The method also includes controlling one or more drilling parameters of a drilling system based on the measurements.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an embodiment drilling system for drilling an earth formation, in accordance with the present disclosure;

FIG. 2 illustrates an embodiment of a drill string of the drilling system having a measurement system in a first configuration, in accordance with the present disclosure;

FIG. 3 illustrates an embodiment of the drill string of the drilling system having the measurement system in a second configuration, in accordance with the present disclosure;

FIG. 4 is a closeup of an embodiment of a sensor of the measurement system taken within an area 2-2 of FIG. 2, in accordance with the present disclosure;

FIG. 5 is a flowchart of an example process for operating the measurement system, in accordance with the present disclosure;

FIG. 6 is a graph of an embodiment of a curve used for determining a ratio of spacings between pairs of sensors of the measurement system, in accordance with the present disclosure;

FIG. 7 illustrates an embodiment of the drill string of the drilling system having a symmetrical sensor arrangement with outer transmitters, in accordance with the present disclosure;

FIG. 8 illustrates an embodiment of the drill string of the drilling system having a symmetrical sensor arrangement with outer receivers, in accordance with the present disclosure;

FIG. 9 illustrates an embodiment of the drill string of the drilling system having an asymmetrical sensor arrangement having first and second offset transmitters, in accordance with the present disclosure; and

FIG. 10 illustrates an embodiment of the drill string of the drilling system having an asymmetrical sensor arrangement having an offset receiver and an offset transmitter, in accordance with the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

As mentioned above, it is desirable to develop techniques for increasing the sensitivity of an electromagnetic signal of the ground formation surrounding a drill string while concurrently decreasing the spreading loss of the signal. One factor that affects both the sensitivity and spreading loss of an electromagnetic signal traveling from a transmitter to a receiver is the distance from the transmitter to the receiver. As the transmitter and receiver are moved closer together, the spreading loss of the signal decreases and the sensitivity of the signal also decreases. As the transmitter and receiver are moved farther apart, the spreading loss of the signal increases and the sensitivity of the signal also increases.

Accordingly, it is presently recognized that it is advantageous to develop an arrangement of receivers and transmitters along the drill string that includes varying distances between the transmitters and receivers to decrease the spreading loss of the signal while concurrently increasing the signal sensitivity. In general, the present disclosure describes an arrangement in which a first transmitter is placed close to the drill bit so that measurements of the formation may be received earlier. The remaining transmitters and receivers are disposed uphole from the first transmitter further away from the drill bit, wherein the remaining transmitters are nested between the receivers. A distance between the first transmitter and the remaining transmitters is greater than a distance between the remaining transmitters and the receivers. A controller may receive a first signal based on the measurements taken by the first transmitter and the receivers. The controller may also receive a second signal based on measurements taken by the remaining transmitters and receivers. The controller may augment the first signal based on the second signal to determine a signal that has increased sensitivity to the formation and decreased spreading loss. This augmented signal may then be used to generate a map of the formation and/or used to steer the drill string. The present disclosure also describes a mathematical model (e.g., curve) that may be used to adjust the configuration of the transmitters and receivers, so as to reduce an apparent resistivity error in the sensor response. The mathematical model may be incorporated into a computer model stored on memory and executable by a processor of a computer system, such as a processor-based controller of a drilling system.

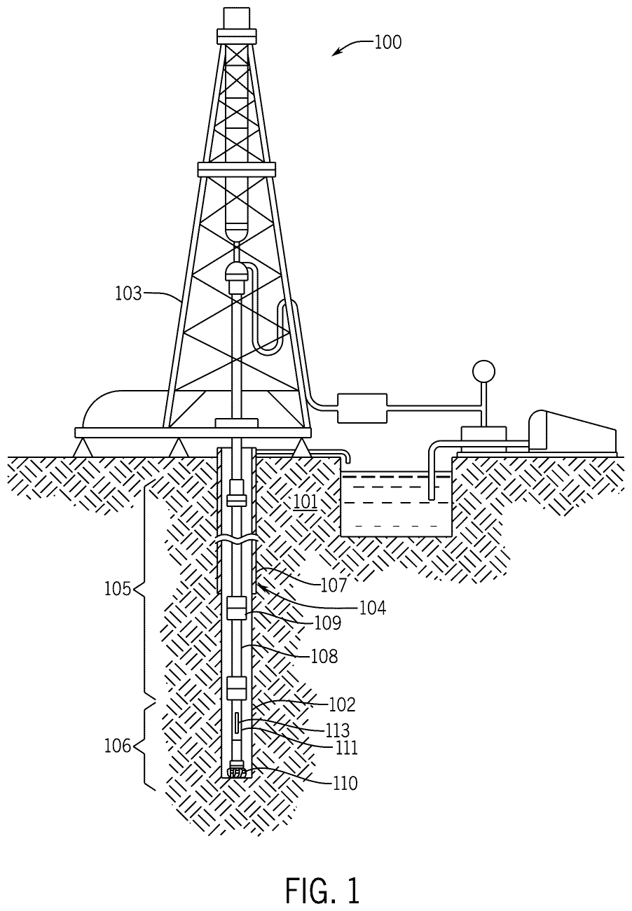

With the foregoing in mind, FIG. 1 shows one example of a drilling system 100 for drilling a geological formation 101 (e.g., subterranean geological formation or simply formation) to form a borehole 102. The drilling system 100 includes a drill rig 103 used to support and rotate a drilling tool assembly 104 that extends downward into the borehole 102. The drilling tool assembly 104 may include a drill string 105 (e.g., including a tool string), a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through the borehole 102 and transmits rotational power from the drill rig 103 to the BHA 106. In some embodiments, the drill string 105 further includes additional components, such as subs, pup joints, and so forth. The drill pipe 108 provides a hydraulic passage through which drilling fluid is pumped from the surface. The drilling fluid discharges through nozzles, jets, or other orifices in the bit 110 and/or the BHA 106 for the purposes of cooling the bit 110 and cutting structures thereon, and for transporting cuttings out of the borehole 102.

The BHA 106 may include the bit 110, a rotary steering system (RSS) 111, or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing downhole well tools. The bit 110 may also include other cutting structures in addition to or other than a drill bit, such as milling or underreaming tools. The RSS 111 may include one or more apertures 113 through which a propellant (e.g., emission, gases, etc.) is expelled to steer the drill string 105 and the BHA 106. For example, the RSS 111 may be used to steer the drill string 105 and the BHA 106 around obstacles.

In general, the drilling system 100 may include other drilling components and accessories, such as make-up/break-out devices (e.g., iron roughnecks or power tongs), valves (e.g., kelly cocks, blowout preventers, and safety valves), other components, or combinations of the foregoing. Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading formation or other downhole materials. For instance, the bit 110 may be a drill bit suitable for drilling the geological formation 101. Example types of drill bits used for drilling earth formations are fixed-cutter or drag bits, roller cone bits, and percussion hammer bits. In some embodiments, the bit 110 is an expandable underreamer used to expand a wellbore diameter. In other embodiments, the bit 110 is a mill used for removing metal, composite, elastomer, other downhole materials, or combinations thereof. For instance, the bit 110 may be used with a whipstock to mill into a casing 107 lining the borehole 102. The bit 110 may also be used to mill away tools, plugs, cement, and other materials within the borehole 102, or combinations thereof. Swarf or other cuttings formed by use of a mill may be lifted to surface, or may be allowed to fall downhole.

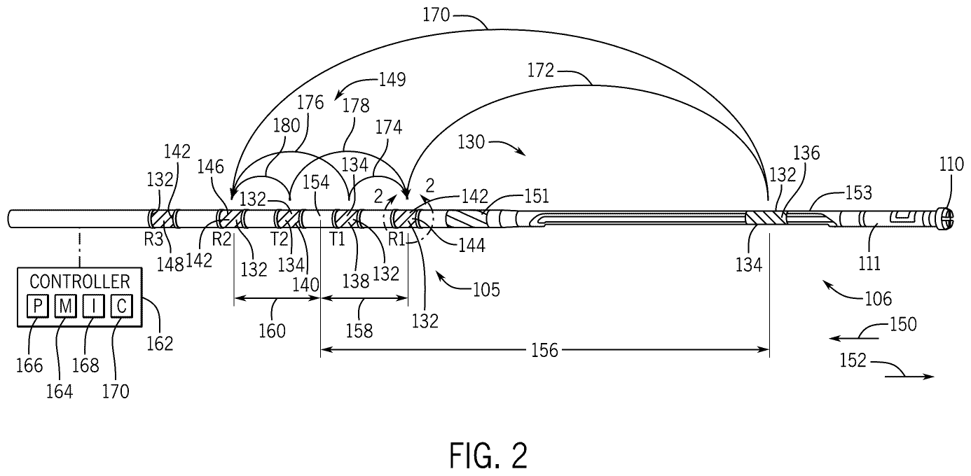

FIG. 2 illustrates an embodiment of the drilling string 105 and the BHA 106 of the drilling system 100 having a measurement system 130 (e.g., electromagnetic signal measurement system) of a first configuration. In the illustrated embodiment, the measurement system 130 includes a plurality of sensors 132 (e.g., sensor pairs, transmitter-receiver pairs, etc.) axially disposed along the drill string 105 and the BHA 106. In certain embodiments, the plurality of sensors 132 may include biaxial antennas, triaxial antennas, or a combination thereof. As shown, the plurality of sensors 132 includes a plurality of transmitters 134 (e.g., transmitters 136, 138, and 140) and a plurality of receivers 142 (e.g., receivers 144, 146, and 148).

In the illustrated embodiment, the transmitter 136 is labeled as T0, the transmitter 138 is labeled as T1, the transmitter 140 is labeled as T2, the receiver 144 is labeled as R1, the receiver 146 is labeled as R2, and the receiver 146 is labeled as R3. As shown, the receiver 144, the transmitter 138, the transmitter 140, the receiver 146, and the receiver 148 are arranged in an axial sequence 149. In certain embodiments, the receiver 144, the transmitter 138, the transmitter 140, the receiver 146, and the receiver 148 are disposed in an uphole direction 150 of a spacer 151 (e.g., spacer collar). As discussed herein, the measurement system 130 may emit electromagnetic signal(s) via the plurality of transmitters 134 into the geological formation 101 surrounding the drilling string 105. The signals, after passing through the geological formation 101, may be received by the plurality of receivers 142, thereby providing one or more measurements (e.g., a map) indicative of one or more parameters (e.g., density, composition, etc.) of the geological formation 101 surrounding the drill string 105.

In certain embodiments, the locations of the plurality of transmitters 134 and the plurality of receivers 142 may be reversed. That is, in certain embodiments, the plurality of sensors 132 includes a plurality of sensor portions and a plurality of additional sensor portions, such that each sensor portion of the plurality of sensor portions includes a transmitter 134 and each additional sensor portion of the plurality of sensor portions includes a receiver 142. In certain embodiments, each sensor portion of the plurality of additional sensor portions includes a receiver 142 and each additional sensor portion of the plurality of additional sensor portions includes a transmitter 134.

In the illustrated embodiment, the transmitter 136 (e.g., first sensor portion) is disposed on the BHA 106 proximate to the bit 110. The transmitters 138 and 140 (e.g., remaining sensor portions) are disposed in the uphole direction 150 from the transmitter 136. As shown, the transmitter 138 (e.g., second sensor portion) and the transmitter 140 (e.g., third sensor portion) are nested between the plurality of receivers 142. That is, at least one of the plurality of receivers 142 is disposed in the uphole direction 150 from the transmitters 138 and 140, and at least one of the plurality of receivers 142 is disposed in a downhole direction 152 from the plurality of receivers 142. In certain embodiments, the transmitter 136 may be integrated with the RSS 111 of the BHA 106, such that the transmitter 136 is proximate (e.g., near) the bit 110. For example, the transmitter 136 may be mounted above a roll-stabilized control unit 153 (e.g., RSS control system) that directs actuators of the RSS 111. It may be appreciated that by placing the transmitter 136 proximate to the bit 110, the sensors 132 may receive measurements of the formation that are closer to the bit 110, such that an anomaly (e.g., obstacle) in the measurements can be received and avoided prior to the bit 110 encountering the anomaly. In certain embodiments, the transmitter 136 may be disposed less than 3.5 meters (m), 3.0 m, 2.5 m, 2.0 m, or 1.5 m away from the bit 110.

In the illustrated embodiment, the receiver 144 (e.g., first additional sensor portion) is disposed in the downhole direction 152 from the transmitters 138 and 140, and the receivers 146 and 148 (e.g., second additional sensor portion) are disposed in the uphole direction 150 from the transmitters 138 and 140. Although the illustrated embodiment shows three transmitters 134 and three receivers 142, in certain embodiments there may be fewer or more than three transmitters 134 and/or receivers 142. For example, the measurement system 130 may include 2, 4, 5, 6, 7, or more transmitters 134 and/or receivers 142. In certain embodiments, the remaining sensor portions may include more than two transmitters 134 and/or receivers 142.

In the illustrated embodiment, the transmitter 136 (e.g., midpoint of the transmitter 136) is separated from a midpoint 154 (e.g., an axial midpoint) of an axial range (e.g., total axial distance) the group of transmitters 138 and 140 (e.g., remaining sensor portions) by a first distance 156 (e.g., axial distance). The midpoint 154 of the transmitters 138 and 140 is separated from the receiver 144 (e.g., midpoint of the receiver 144) by a second distance 158 (e.g., axial distance), and the midpoint 154 is separated from the receiver 146 (e.g., midpoint of the receiver 146) by a third distance 160 (e.g., axial distance). As shown, the first distance 156 is greater than each of the second distance 158 and third distance 160. In certain embodiments, the second distance 158 and the third distance 160 have the same (e.g., equivalent) magnitude. In certain embodiments, the first distance 156 is between 2 m and 7 m, 3 m and 6 m, or 4 m and 5 m. Additionally or alternatively, the second distance 158 and/or the third distance 160 may be between 0.3 m and 0.9 m, 0.4 m and 0.8 m, or 0.5 m and 0.7 m. In certain embodiments, a ratio between the second distance 158 (e.g., and/or the third distance 160) and the first distance 156 is between 1:15 and 4:15. In certain embodiments, the first distance 156 is equal to or greater than 3, 4, 5, 6, 7, 8, 9, 10, 11, 12, 13, 14, or 15 times the second distance 158 and/or the third distance 160.

In the illustrated embodiment, the measurement system 130 includes a controller 162 having a memory 164 and a processor 166 configured to execute instructions 168 stored in the memory 164 via circuitry 170. The controller 162 is communicatively coupled (e.g., wired and/or wirelessly coupled) to the plurality of sensors 132. The controller 162 may be configured to receive a first signal indicative of a first measurement based on the transmitter 136 (e.g., first sensor portion) and the receivers 142 (e.g., plurality of additional sensor portions). The controller 162 may also be configured to receive a second signal indicative of a second measurement based on the transmitters 138 and 140 (e.g., remaining sensor portions) and the receivers 142 (e.g., plurality of additional sensor portions). The controller 162 may be configured to determine a quantity that is independent of antenna and electronics gains based on the following equation:

$$M 0 = \frac{{V}_{DC \_ 02}}{{V}_{DC \_ 01}} \sqrt{\frac{{V}_{DC \_ 11} {V}_{DC \_ 21}}{{V}_{DC \_ 12} {V}_{DC \_ 22}}}$$

In the above equation, M0 is the quantity that is independent of antenna and electronics gains, V_{DC_02} is a signal 170 measured on the receiver 146 from the transmitter 136, V_{DC_01} is a signal 172 measured on the receiver 144 from the transmitter 136, V_{DC_11} is a signal 174 measured on the receiver 144 from the transmitter 138, V_{DC_12} is a signal 176 measured on the receiver 146 from the transmitter 138, V_{DC_21} is a signal 178 measured on the receiver 144 from the transmitter 140, and V_{DC_22} is a signal 180 measured on the receiver 146 from the transmitter 140. In certain embodiments, V_{DC_02}, V_{DC_01}, V_{DC_11}, V_{DC_12}, V_{DC_21}, and/or V_{DC_22} may be the zz or the xx+yy tensor elements of the corresponding signals.

Additionally or alternatively, the controller 162 may be configured to determine a quantity M1 based on the following equation:

$$M 1 = \sqrt{\frac{{V}_{DC \_ 12} {V}_{DC \_ 21}}{{V}_{DC \_ 11} {V}_{DC \_ 22}}}$$

In the above equation, the quantities are substantially the same as the quantities used for determining M0. It may be appreciated that the signal(s) 174, 176, 178, and/or 180 may be used to compensate the signal(s) 170 and 172 to minimize the spreading loss of the signals 170 and 172 while also maximizing sensitivity to the formation.

It may be appreciated that the illustrated configuration of the plurality of sensors 132 may improve (e.g., minimize) the spreading loss of the electromagnetic signals while also improving (e.g., maximizing) sensitivity to the formation surrounding the drill string 105. This objective is accomplished by compensating the signal(s) 170 and 172, which have a high spreading loss and low sensitivity, with the signal(s) 174, 176, 178, and/or 180, which have a low spreading loss and higher sensitivity.

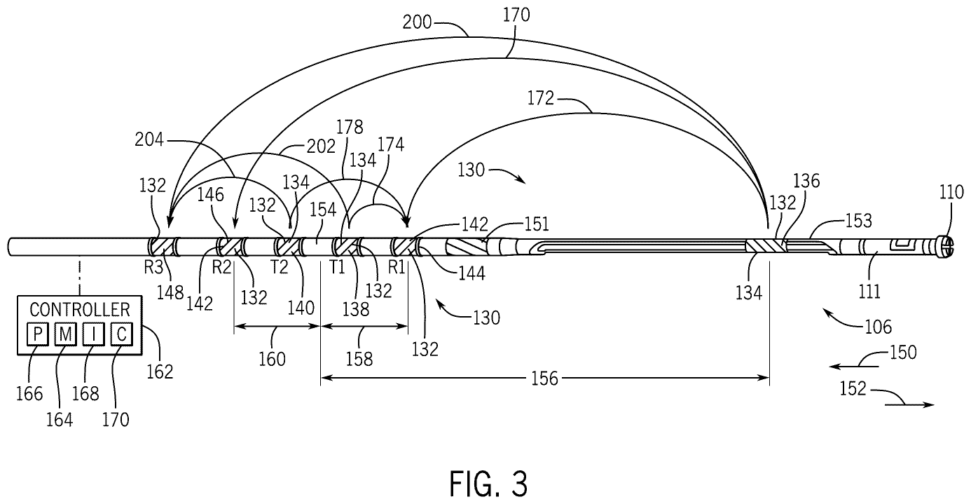

FIG. 3 illustrates an embodiment of the drilling string 105 and the BHA 106 of the drilling system 100 having the measurement system 130 in a second configuration. The reference numbers in FIG. 3 are substantially the same as those used in FIG. 2. In the illustrated embodiment, an additional compensated depth of investigation is provided by combining the measurements received from the signal(s) 174, 176, 178, and/or 180 with additional signals 200, 202, and 204. As shown, the transmitters 138 and 140 transmit a signal to the receiver 148, which is disposed in the uphole direction 150 of the receiver 146, and the transmitter 136 may transmit the signal 200 to the receiver 148. It may be appreciated that the greater distance between the receiver 148 and the transmitters 138 and 140 may enable compensation of the signal(s) 170 and/or 200 based at an additional depth of investigation. In certain embodiments, the controller 162 may be configured to determine a third quantity M2 according to the following equation:

$$M 2 = \frac{{V}_{DC \_ 13}}{{V}_{DC \_ 23}} \sqrt{\frac{{V}_{DC \_ 22} {V}_{DC \_ 21}}{{V}_{DC \_ 12} {V}_{DC \_ 11}}}$$

In the above equation, V_{DC_13} is the signal 202 measured on the receiver 148 from the transmitter 138 and V_{DC_23} is the signal 202 measured on the receiver 148 from the transmitter 140. The remaining variables are the same as described in relation to the equation for determining M0 and M1. In certain embodiments, V_{DC_13}, V_{DC_23}, V_{DC_11}, V_{DC_12}, V_{DC_21}, and/or V_{DC_22} may be the zz or the xx+yy tensor elements of the corresponding signals. Examples of tensor elements corresponding to these signals may be found in U.S. Pat. No. 11,112,523 B2 (Frey 2021), which is incorporated by reference herein.

In certain embodiments, the controller 162 may be configured to switch between the configuration shown in FIG. 2 and the configuration shown in FIG. 3. That is, the controller 162 may be configured to switch between compensation based on the transmitter 136 and the receiver 146 and compensation based on the transmitter 136 and the receiver 148. For example, the controller 162 may be configured to gather formation measurements using the transmitter 136 and the receiver 146 as shown in the configuration in FIG. 2 and after a duration of time switch to gathering formation measurements using the transmitter 136 and the receiver 148 as shown in FIG. 3. In certain embodiments, the controller 162 may receive formation data using a combination of the configurations shown in FIGS. 2 and 3. For example, the controller 162 may be configured to concurrently measure the formation via the configuration shown in FIGS. 2 and 3. It may be recognized that although FIGS. 2 and 3 show three transmitters 134 and three receivers 142, fewer or more transmitters 134 and receivers 142.

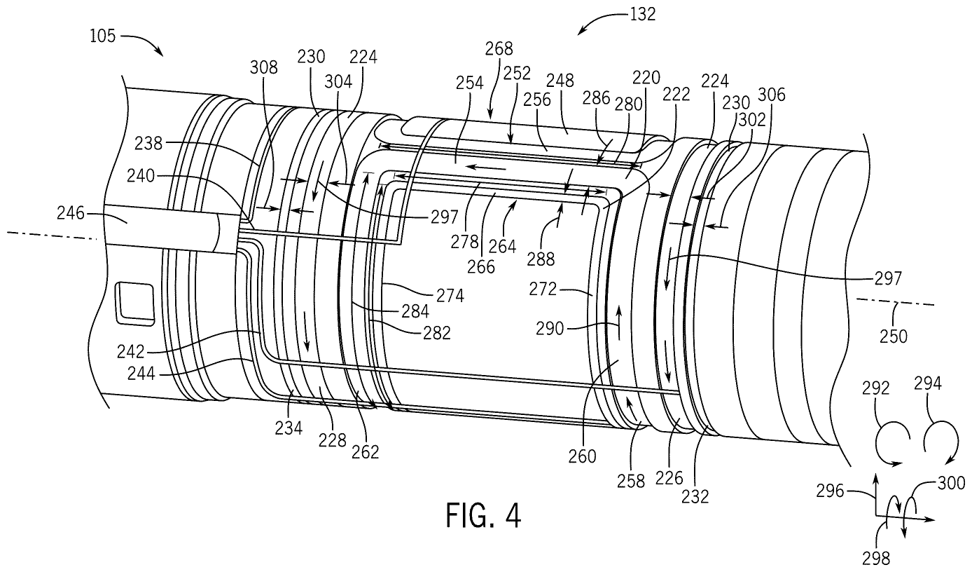

FIG. 4 is a closeup of an embodiment of the sensor 132 of the measurement system 130 taken within an area 2-2 of FIG. 2. In the illustrated embodiment, the sensor 132 includes a low frequency saddle coil 220, a high frequency saddle coil 222, low frequency axial coils 224 (e.g., low frequency axial coils 226, 228), and high frequency axial coils 230 (e.g., high frequency axial coils 232, 234). The sensor 132 also includes leads 236 (e.g., leads 238, 240, 242, 244) that electrically couple the low frequency saddle coil 220, the high frequency saddle coil 222, the low frequency axial coils 224, and the high frequency axial coils 230 to a relay 246. As discussed herein, in certain embodiments, the sensor 132 may be a transmitter or a receiver.

In the illustrated embodiment, the low frequency saddle coil 220 and the high frequency saddle coil 222 are formed into a circumferential surface 248 (e.g., collar) of the sensor 132. As shown, each of the low frequency saddle coil 220 and the high frequency saddle coil 222 form closed loops (e.g., closed circuits) that are circumferentially disposed about a central axis 250 of the drill string 105. In the illustrated embodiment, the low frequency saddle coil 220 has a rectangular shape that curves circumferentially about the central axis 250. As shown, the low frequency saddle coil 220 includes flat sides 252 (e.g., flat sides 254, 256) and curved sides 258 (e.g., curved sides 260, 262). The high frequency saddle coil 222 also has a rectangular shape that curves circumferentially about the central axis 250. As shown, the high frequency saddle coil 222 includes flat sides 264 (e.g., flat sides 266, 268) and curved sides 270 (e.g., curved sides 272, 274).

In the illustrated embodiment, the high frequency saddle coil 222 is circumscribed by the low frequency saddle coil 220, such that the high frequency saddle coil 222 is enclosed by a perimeter 276 of the low frequency saddle coil 220. As shown, a length 278 of the flat sides 264 of the high frequency saddle coil 222 is less than a length 280 of the flat sides 252 of the low frequency saddle coil 220. Additionally, an arcuate length 282 of the curved sides 270 of the high frequency saddle coil 222 is less than an arcuate length 284 of the curved sides 258 of the low frequency saddle coil 220. The low frequency saddle coil 220 includes more windings than the high frequency saddle coil 222, hence a thickness 286 of the low frequency saddle coil 220 is greater than a thickness 288 of the high frequency saddle coil 222. It may be appreciated that by having a larger number of windings, the low frequency saddle coil 220 may be fired at lower frequencies to maximize the effective turn area, whereas the high frequency saddle coil 222 has a lower number of windings to minimize the errors from coil self-resonance. As shown, a current 290 flowing through the low frequency saddle coil 220 is in a counterclockwise direction 292. In certain embodiments, the current 290 may flow in a clockwise direction 294. In certain embodiments, the low frequency saddle coil 220 and/or the high frequency saddle coil 222 may emit or receive a signal in a radial direction 296 (e.g., normal direction) that is normal to the circumferential surface 248.

In the illustrated embodiment, the low frequency axial coil 226 is disposed in the downhole direction 152 relative to the low frequency saddle coil 220 and the high frequency saddle coil 222, and the low frequency saddle coil 228 is disposed in the uphole direction 150 relative to the low frequency saddle coil 220 and the high frequency saddle coil 222. As shown, the low frequency axial coils 226 and 228 are circumferentially disposed about the central axis 250 of the drill string 105. In the illustrated embodiment, the current 296 in the low frequency saddle coils 226 and 228 is shown as traveling in the circumferential direction 292. In certain embodiments, the current 296 may travel in the circumferential direction 294.

In the illustrated embodiment, the high frequency axial coil 232 is disposed in the downhole direction 152 relative to the low frequency axial coil 226, and the high frequency axial coil 234 is disposed in the uphole direction 150 relative to the low frequency axial coil 228. As shown, the low frequency axial coils 226 and 228 are circumferentially disposed about the central axis 250 of the drill string 105. As shown, the high frequency axial coils 232 and 234 are circumferentially disposed about the central axis 250 of the drill string 105. The low frequency saddle coils 226 and 228 include more windings than the high frequency axial coils 232 and 234, hence thicknesses 302 and 304 of the low frequency axial coils 226 and 228 are greater than thicknesses 306 and 308 of the high frequency axial coils 232 and 234. In certain embodiments, the low frequency axial coil 226 and the high frequency axial coil 232 may emit and/or receive a signal in/from the downhole direction 152, and the low frequency axial coil 228 and the high frequency axial coil 234 may emit and/or receive a signal in/from the uphole direction 150. In the illustrated embodiment, a current 297 travels in the circumferential direction 300 through the low frequency axial coils 226 and 228. In certain embodiments, the current 297 may travel in the circumferential direction 298.

In the illustrated embodiment, the low frequency saddle coil 220, the high frequency saddle coil 222, the low frequency axial coils 224, and the high frequency axial coils 230 are electrically coupled to the relay 246 via the leads 236. In certain embodiments, the controller 162 may instruct the relay 246 to energize (e.g., activate, turn on) and/or de-energize coils having the same polarity to mitigate coils with the same polarization form inducing currents in the other coil. For example, the controller 162 may control the relay to energize and/or de-energize any combination of the low frequency saddle coil 220, the high frequency saddle coil 222, the low frequency axial coils 224, and the high frequency axial coils 230.

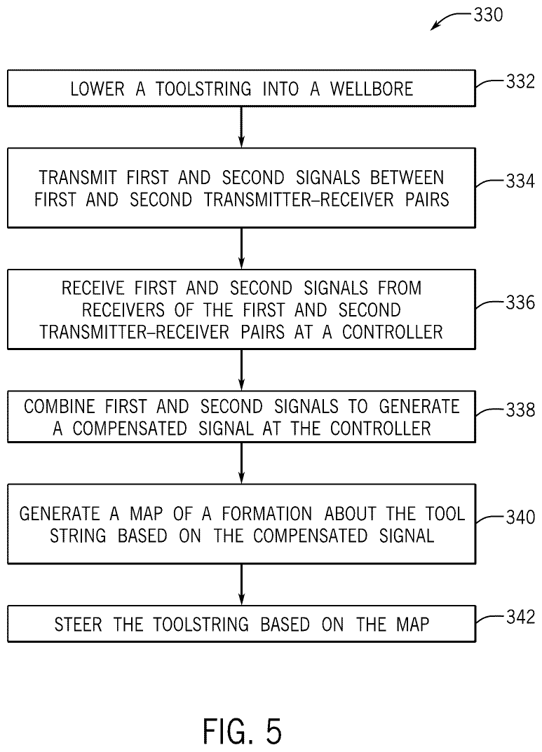

FIG. 5 is a flowchart of an example process 330 for operating the measurement system 130. The process 330 may be performed by the controller 162 of FIGS. 2 and 3. Additionally or alternatively, the process 330 may be performed any other suitable computing device(s) or controller(s). Furthermore, the blocks of the process 330 may be performed in the order disclosed herein or in any other suitable order. For example, certain blocks of the process 330 may be performed concurrently. In addition, in certain embodiments, at least one of the blocks of the process 330 may be omitted.

In block 332 of the process 330, the drill string 105 is lowered into a wellbore. In certain embodiments, the drill string 105 may be accompanied by the BHA 106 coupled to a downhole end of the drill string 105. As discussed herein, the BHA 106 includes the bit 110 and the RSS 111. In certain embodiments, the drill string 105 may be lowered via the drilling rig 103.

In block 334 of the process 330, the controller 162 transmits first and second signals between first and second transmitter-receiver pairs. For example, a first signal may be transmitted from the transmitter 136 (e.g., sensor portion) of the plurality of transmitters 134 (e.g., plurality of sensor portions) to one or more receivers 142 (e.g., additional sensor portion). By further example, a second signal may be transmitted from the transmitters 138 and 140 (e.g., remaining transmitters 134) to the one or more receivers 142. In certain embodiments, the second signal may include one or more signals based on different combinations of the remaining transmitters 134 and the receivers 142. For example, the second signal may include the signal(s) 174, 176, 178, and/or 180.

As discussed herein, the transmitter 136 is disposed on the BHA 105, and the plurality of transmitters 134 and the one or more receivers 142 are disposed on the drill string 105, uphole of the transmitter 136. In certain embodiments, the locations of the plurality of transmitters 134 and the plurality of receivers 142 may be reversed. A distance between a midpoint (e.g., axial midpoint) of the remaining transmitters 134 and the receivers 142 is less than a distance between the transmitter 136 and the receivers 142.

In block 336 of the process 330, the controller 162 receives the first and second signals. For example, the controller 162 may receive the first and second signals from the one or more receivers 142. In certain embodiments, the controller 162 may receive the first and second signals from the plurality of transmitters 134.

In block 338 of the process 330, the controller 162 may combine the one or more first signals and the one or more second signals to obtain a compensated signal that is increased in sensitivity and decreased in spreading loss based on the combination of the one or more first signals and the one or more second signals. In certain embodiments, the controller 162 may determine one or more compensated quantities based at least on the one or more first signals and the one or more second signals. The spacing between the receivers 142 and the transmitters 134 is discussed in further detail herein. For example, the one or more compensated quantities may include one or more compensated transmitter gains, one or more compensated receiver gains, or both. In certain embodiments, the controller 162 may be configured to compensate the gains of a subset of the plurality of sensors 132 or, in certain embodiments, all of the sensors 132.

In block 340 of the process 330, the controller 162 may generate a map of a formation about the tool string based on the first signal, the second signal, or a combination thereof. For example, the controller 162 may use the augmented (e.g., improved) combination of the first and second signals obtained in the block 338 to detect one or more obstacles in the surrounding formation. Additionally or alternatively, the generated map may be used for determining areas with a higher density of hydrocarbons.

In block 342 of the process 330, the controller 162 may steer the drill string 105 and/or the BHA 106 based on the generated map. For example, the controller 162 may control the RSS 111 to steer the drill string 105 and/or the BHA 106 to avoid one or more obstacles and/or to reach a location with a higher density of hydrocarbons. In certain embodiments, the controller 162 may iterate back to block 334 to receive new data and generate a new map and steer the drill string 105 and/or the BHA 106 based on the updated map.

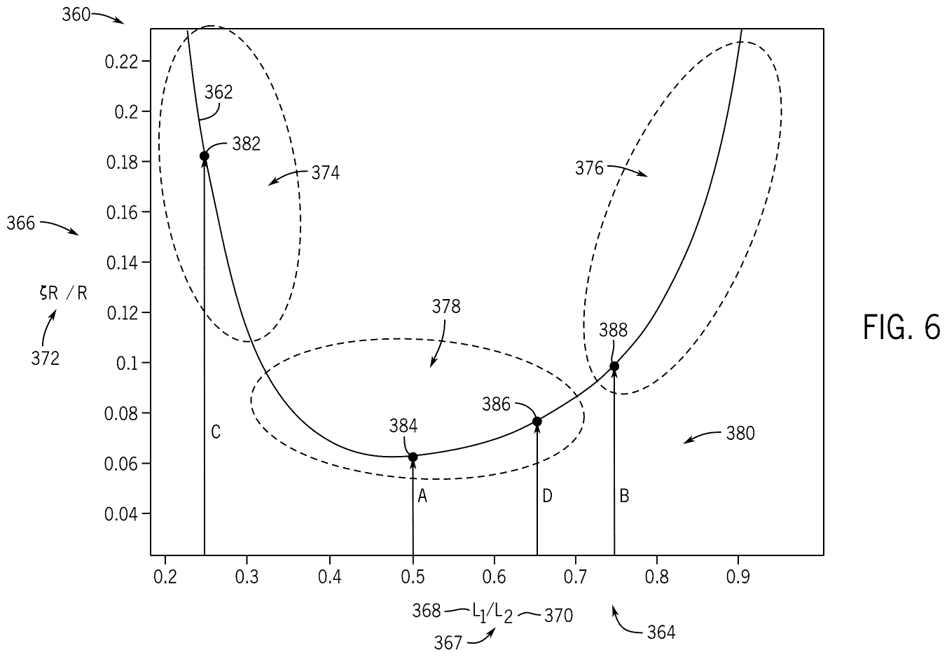

FIG. 6 is a graph 360 of an embodiment of a curve 362 used for determining a ratio of spacings between pairs of sensors of the measurement system 130. In the illustrated embodiment, the graph 360 includes a ratio axis 364 and an apparent resistivity error axis 366. As discussed herein, a ratio 367 quantified by the ratio axis 364 is a ratio between a first spacing 368 (e.g., L1) of a first pair of sensors and a second spacing 370 (e.g., L2) of a second pair of sensors. Each pair of sensors (e.g., first and second pairs of sensors) is generally a transmitter-receiver pair of sensors. In certain embodiments, the first spacing 368 is the spacing between a first transmitter (e.g., T1′) and a first receiver (e.g., R1′), and the second spacing 370 is the spacing between T1′ and a second receiver (e.g., R2). In certain embodiments, the first spacing 368 is the spacing between T1′ and R1′, and the second spacing 370 is the spacing between a second transmitter (e.g., T2′) and R1′.

In certain embodiments, in reference to FIG. 3, T1′ may correspond to transmitter 138 (T1), T2′ may correspond to transmitter 140 (T2), R1′ may correspond to receiver 132 (R1), and R2′ may correspond to receiver 142 (R2). Additionally or alternatively, T1′, T2′, R1′, and R2′ may correspond to pairings between a group of proximate sensors (e.g., T1, T2, R1, R2) and one or more offset sensors. For example, T1′ may correspond to T1, T2′ may correspond to T2, and R1′ may correspond to the receiver 148 (R3). By further example, T1′ may correspond to transmitter 136, R1′ may correspond to R1, and R2′ may correspond to R2.

The apparent resistivity error axis 366 represents an apparent resistivity error 372 (i.e., δR/R). The apparent resistivity error 372 is inversely related to a phase shift error (i.e., δPS) between the first and second pairs of sensors. The phase shift error is determined based on the following equation:

$$δ PS = \sqrt{[ {( \frac{δ {V}_{n}}{{V}_{12}} )}^{2} + {( \frac{δ {V}_{n}}{{V}_{11}} )}^{2} ] + {( \frac{{V}_{11}}{{V}_{12}} δ {V}_{q} )}^{2}}$$

In the above equation, δVₙ is the measurement noise (e.g., response noise) of the measurements received from the pairs of sensors, δV_{q} is the quantization error, V₁₁ is the response measured by the first receiver from the first transmitter, and V₁₂ is the response measured by the second receiver from the first transmitter (e.g., or alternatively the response measured by the first receiver from a second transmitter). The quantization error δVg is the error due to the finite dynamic range of the receiver electronics analog-to-digital converter and/or systematic errors that limit the dynamic range (e.g., electronic crosstalk between the transmitter and receiver). As the ratio 367 between L1 and L2 decreases (e.g., difference in signals increase), the phase shift error δPS increases due to the rapid increase of the

$$\frac{{V}_{11}}{{V}_{12}}$$

factor that multiplies the quantization error δV_{q}. The response V₁₁ may be determined based on the following approximation:

$${V}_{11} ∼ \frac{{e}^{i k {L}_{1}} ( 1 - ik {L}_{1} )}{{L}_{1}^{3}}$$

In the above approximation, k is the wave number, which may be approximated using the following approximation:

$$k \approx \sqrt{i ω μ σ}$$

In the above approximation, ω is the angular frequency of operation, μ is the permeability of the medium, and σ is the conductivity. At high resistivities (e.g., low conductivity, low wave number k), the phase shift is approximately proportional to the wave number k multiplied by the receiver spacing, as follows:

$$P S ∼ k ( {L}_{2} - {L}_{1} )$$

In the above approximation, PS is the phase shift. In certain embodiments, the phase shift PS and/or the phase shift error δPS may be used to at least partially determine the apparent resistivity error 372 (i.e., δR/R) for a given ratio 367 of sensor spacings L1 and L2.

As shown in the graph 360, the curve 362 shows an increased apparent resistivity error 372 when the ratio 367 is low and when the ratio 367 is high. In the lefthand region 374 of the curve 362, the apparent resistivity error 372 increases as the ratio 367 decreases due to the increase in the quantization error term

$$( e . g . , \frac{{V}_{11}}{{V}_{12}} δ {V}_{q} )$$

caused by the disparity in signal strength, based at least in part on the disparity in sensor spacings L1 and L2. In the righthand region 376 of the curve 362, the apparent resistivity error 372 increases as the ratio 367 approaches 1, based at least in part on a decreased sensitivity due to the sensor signals being close together, based at least in part on the similarity between the sensor spacings L1 and L2. The similarity of signal strength is based at least in part on the sensor spacings L1 and L2 being close to each other. As shown, the apparent resistivity error 372 increases more quickly in the lefthand region 374 than in the righthand region 376. The curve 362 also includes a middle region 378 in which the apparent resistivity error 372 is decreased. As shown, the middle region 378 is located where the ratio 367 ranges from approximately 0.35 to 0.75. The range of the ratio 367 of the sensor spacings L1 and L2 is described in further detail herein.

In the illustrated embodiment, the graph 360 includes points 380 (e.g., points 382, 384, 386, 388) located on the curve 362. As shown, the point 382 (i.e., C) is disposed in the left hand region 374 and corresponds to the ratio 367 having a low value (e.g., between 0.2 and 0.3) and a high apparent resistivity error 372 (e.g., between 0.16 and 0.2). The point 384 (i.e., A) and the point 386 (i.e., D) are disposed in the middle region 378, and correspond to the ratio 367 having a medium value (e.g., between 0.35 and 0.75) and corresponding low apparent resistivity errors 372 (e.g., between 0.04 and 0.08). The point 388 (i.e., B) is disposed in the righthand region 376 and corresponds to the ratio 367 having a high value (e.g., between 0.7 and 0.8) and the apparent resistivity error 372 also having a high value (e.g., between 0.08 and 0.1). The conditions that correspond to each of the points 380 are discussed in further detail herein.

It may be appreciated that the curve 362 plotted on the graph 360 enables a user to adjust a configuration of sensors (e.g., sensor configuration of transmitters and receivers), including a spacing between different pairs of sensors, a type (e.g., transmitter or receiver) of sensor to use at a particular location, and/or which pairs of sensors to use for collection of data. For example, as discussed herein, the curve 362 may be used to compare different sensors configurations based on the apparent resistivity error corresponding to selected sensor pairs. In certain embodiments, the curve 363 may be used to select the best configuration of sensors at least partially based on the sensor configurations falling within the middle region 378 of the curve 362.

In certain embodiments, a computer system (e.g., control system or controller) may include a computer model stored in memory and executable by a processor to evaluate various parameters and recommend the configuration of sensors based at least in part on functional relationships depicted in the curve 362 of FIG. 6. In certain embodiments, the computer model may include a mathematical model based on the equations disclosed herein, parameters related to the geological formation, parameters related to the sensors, historical sensor data, user input, a machine learning model and/or artificial intelligence, or any combination thereof. In certain embodiments, the computer model may analyze a plurality of configurations of the sensors, perform simulations of sensor measurements using the plurality of configurations, evaluate the plurality of configurations based on the curve 362, rank the plurality of configurations based on best to worst performance, and recommend one or more of the configurations for the sensors via an electronic display.

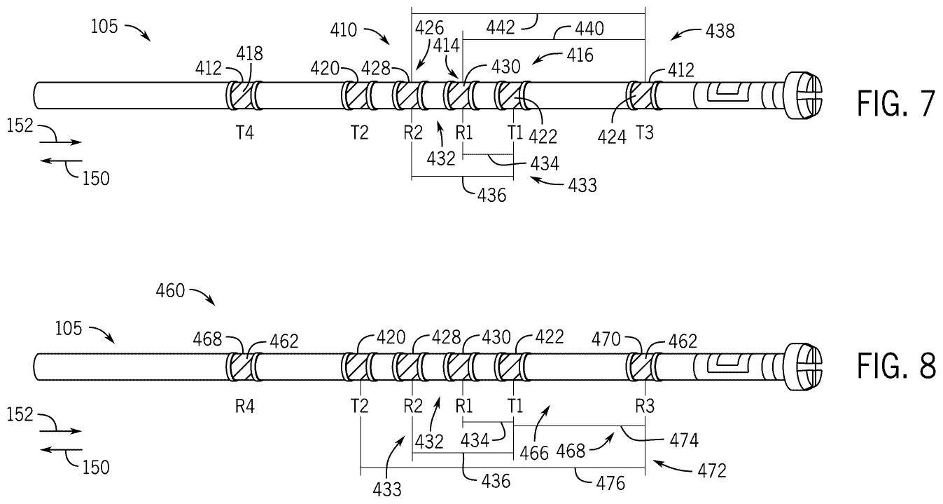

FIG. 7 illustrates an embodiment of the drill string 105 of the drilling system 100 having a symmetrical sensor arrangement 410 with outer transmitters 412. In the illustrated embodiment, the drilling system 100 includes a plurality of sensors 414, which includes a plurality of transmitters 416 (e.g., transmitter 418, 420, 422, 424) and a plurality of receivers 426 (e.g., receiver 428, 430). The plurality of sensors 414 includes a plurality of sensors 432 (e.g., transmitter 420, receiver 428, receiver 430, transmitter 422) that are grouped together with closer spacings, and the outer transmitters 412 (e.g., transmitter 418, transmitter 424) that are spaced further away from the plurality of sensors 432. As shown, the transmitter 418 is disposed in the direction 150 relative to the sensors 432, and the transmitter 424 is disposed in the direction 152 relative to the sensors 432, wherein the directions 150 and 152 are opposite axial directions away from axially opposite sides of the sensors 432. It may be appreciated that the outer transmitters 412 provide an additional depth of measurement from the sensors 432. The sensors 414 as referenced in FIGS. 7-10 may include axial coils, transverse coils, or a combination thereof. Additionally or alternatively, the sensors 414 may include tilted coils that include axial and transverse components.

The response of the transmitter 422 (i.e., T1) based on the received signal from the receiver 430 (i.e., R1) may be determined based on the following equation:

$${V}_{11} = {ℊ}_{T 1} {ℊ}_{R 1} {Z}_{11}$$

In the above equation, V₁₁ is the sensor response (e.g., measured voltage) measured on R1, g_{T1} is the T1 transmitter antenna and electronics gain, g_{R1} is the R1 electronics and antenna gain, and Z₁₁ is the gain-independent coupling between T1 and R1, which depends on the spacing, frequency, and conductivity of the nearby formation. The response measured on the receiver 428 (i.e., R2) when T1 fires may be determined based on the following equation:

$${V}_{12} = {ℊ}_{T 1} {ℊ}_{R 2} {Z}_{12}$$

In the above equation, V₁₂ is the sensor response (e.g., measured voltage) of the signal sent from T1 measured on R2, g_{T1} is the T1 transmitter antenna and electronics gain, g_{R2} is the R2 electronics and antenna gain, and Z₁₂ is the gain-independent coupling between T1 and R2, which depends on the spacing, frequency, and conductivity of the nearby formation. Taking the ratio of the voltages between these two receivers cancels the transmitter gains:

$$\frac{{V}_{12}}{{V}_{11}} = \frac{{ℊ}_{R 2} {Z}_{12}}{{ℊ}_{R 1} {Z}_{11}}$$

The ratio of responses when the transmitter 420 (i.e., T2) is similarly determined by the following equation:

$$\frac{{V}_{21}}{{V}_{22}} = \frac{{ℊ}_{R 1} {Z}_{21}}{{ℊ}_{R 2} {Z}_{22}}$$

In the above equation, V₂₁ is the sensor response (e.g., measured voltage) received from T2 on R1, g_{R1} is the R1 electronics and antenna gain, g_{R2} is the R2 electronics and antenna gain, Z₂₁ is the gain-independent coupling between T2 and R1, and Z₂₂ is the gain-independent coupling between T2 and R2. Combining the above ratios eliminates the receiver gains:

$$\sqrt{\frac{{V}_{12}}{{V}_{11}} \frac{{V}_{21}}{{V}_{22}}} = \sqrt{\frac{{Z}_{12}}{{Z}_{11}} \frac{{Z}_{21}}{{Z}_{22}}}$$

In the illustrated embodiment, the sensors 432 are spaced such that the ratio discussed in reference to FIG. 6 is decreased. As shown, a ratio 433 of a length dimension 434 (L1) from the transmitter 422 (T1) to the receiver 430 (R1) to a length dimension 436 (L2) from the transmitter 422 (T1) to the receiver 428 (R2) is approximated by the point 384 (A) on the curve 362 of the graph 360 shown in FIG. 6. Because the ratio 433 of L1 to L2 falls within the range of 0.35 to 0.75, the apparent resistivity error is low for the sensors 432 (e.g., between 0.06 and 0.08).

As shown, a ratio 438 of a length dimension 440 (i.e., L1′) from the transmitter 424 (T3) to the receiver 430 (R1) to a length dimension 442 (i.e., L2′) from the transmitter 424 (T3) to the receiver 428 (R2) is greater than the ratio 433, and may be approximated by the point 388 (B) on the curve 362 of the graph 360 in reference to FIG. 6. As shown in the graph 360, the apparent resistivity error corresponding to point 388 is approximately 0.1, which is higher than the apparent resistivity error corresponding to point 384 (e.g., approximately 0.06), meaning that the spacing and/or configuration of the sensors 432 may be further improved.

FIG. 8 illustrates an embodiment of the drill string 105 of the drilling system 100 having a symmetrical sensor arrangement 460 with outer receivers 462. In the illustrated embodiment, the drilling system 100 includes a plurality of sensors 464, which includes a plurality of transmitters 466 (e.g., transmitters 420, 422) and a plurality of receivers 468 (e.g., receivers 428, 430, 468, 470). The plurality of sensors 464 includes the plurality of sensors 432 (e.g., transmitter 420, receiver 428, receiver 430, transmitter 422) and the outer receivers 462 (e.g., receivers 468, 470). As shown, the receiver 468 is disposed in the direction 150 relative to the sensors 432, and the receiver 470 is disposed in the direction 152 relative to the sensors 432, wherein the directions 150 and 152 are opposite axial directions away from axially opposite sides of the sensors 432. It may be appreciated that the outer receivers 462 provide an additional depth of measurement from the sensors 432.

In the illustrated embodiment, the sensors 432 are spaced such that the ratio discussed in reference to FIG. 6 remains low. As shown, the ratio 433 of a length dimension 434 (L1) from the transmitter 422 (T1) to the receiver 430 (R1) to the length dimension 436 (L2) from the transmitter 422 (T1) to the receiver 428 (R2) is approximated by the point 384 (A) on the curve 362 of the graph 360 shown in FIG. 6. Because the ratio 433 of L1 to L2 falls within the range of 0.35 to 0.75, the apparent resistivity error is low for the sensors 432 (e.g., between 0.06 and 0.08).

As shown, a ratio 472 of a length dimension 474 (i.e., L1″) from the receiver 470 (R3) to the transmitter 422 (T1) to a length dimension 476 (i.e., L2″) from the receiver 470 (R3) to transmitter 420 (T2) is approximately the same in value as the ratio 433 (e.g., near 0.5), and may be approximated by the point 384 (A) on the curve 362 of the graph 360 in reference to FIG. 6. As shown in the graph 360, the apparent resistivity error corresponding to point 384 is between 0.06 and 0.08. Because both the sensors 432 and the outer receivers 462 have corresponding minimal apparent resistivity errors, the spacing between the sensors 432 is improved by using the outer receivers 462 in place of the outer transmitters 412 of FIG. 7.

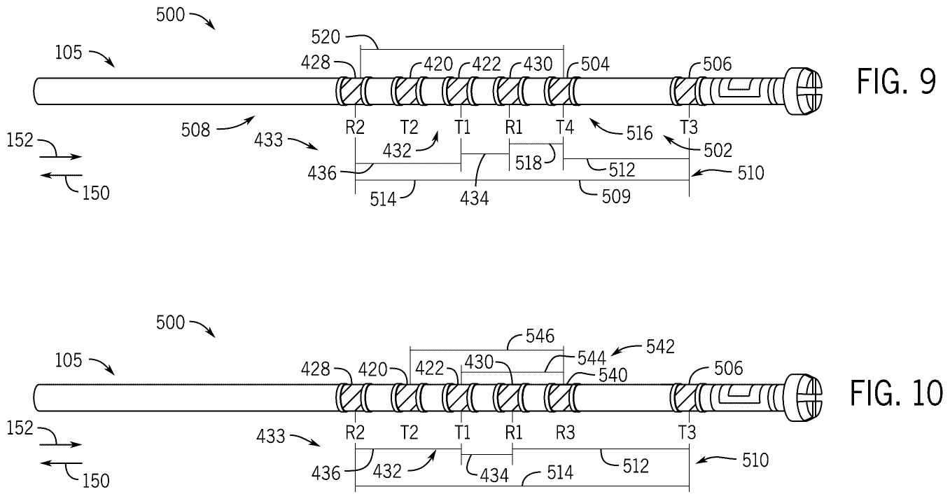

FIG. 9 illustrates an embodiment of the drill string 105 of the drilling system 100 having an asymmetrical sensor arrangement 500 having a plurality of offset transmitters 502 (e.g., offset transmitters 504, 506). As shown, both offset transmitters 502 are disposed in the direction 152 relative to the sensors 432, such that the offset transmitters 502 are axially offset away from only one axial side of the sensors 432. It may be appreciated that by removing a sensor from the axial side 508 in the direction 150 with respect to the sensors 432, an overall length dimension 509 of the sensor arrangement 500 may be reduced relative to the sensor arrangements 410 and 460 described in FIGS. 7 and 8 the sensors may be compensated based on the following equation:

$$\frac{{V}_{32}}{{V}_{31}} \sqrt{\frac{{V}_{11}}{{V}_{22}} \frac{{V}_{21}}{{V}_{12}}} = \frac{{Z}_{32}}{{Z}_{31}} \sqrt{\frac{{Z}_{11}}{{Z}_{22}} \frac{{Z}_{21}}{{Z}_{12}}}$$

In the above equation, V₁₁ is the sensor response (e.g., measured voltage) received from T1 on R1, V₁₂ is the sensor response (e.g., measured voltage) received from T1 on R2, V₂₁ is the sensor response (e.g., measured voltage) received from T2 on R1, V₂₂ is the sensor response (e.g., measured voltage) received from T2 on R2, V₃₁ is the sensor response (e.g., measured voltage) received from T3 on R1, V₃₂ is the sensor response (e.g., measured voltage) received from T3 on R2, Z₁₁ is the gain-independent coupling between T1 and R1, Z₁₂ is the is the gain-independent coupling between T1 and R2, Z₂₁ is the gain-independent coupling between T2 and R1, Z₂₂ is the gain-independent coupling between T2 and R2, Z₃₁ is the gain-independent coupling between T3 and R1, and Z₃₂ is the gain-independent coupling between T3 and R2.

In the illustrated embodiment, the sensors 432 are spaced such that the ratio discussed in reference to FIG. 6 remains low. As shown, the ratio 433 of the length dimension 434 (L1) from the transmitter 422 (T1) to the receiver 430 (R1) to the length dimension 436 (L2) from the transmitter 422 (T1) to the receiver 428 (R2) is approximated by the point 384 (A) on the curve 362 of the graph 360 shown in FIG. 6. Because the ratio 433 of L1 to L2 falls within the range of 0.35 to 0.75, the apparent resistivity error is low for the sensors 432 (e.g., between 0.06 and 0.08).

In the illustrated embodiment, a ratio 510 of a length dimension 512 (i.e., L1″) from the offset transmitter 506 (e.g., T3) to the receiver 430 (R1) to a length dimension 514 (i.e., L2″) from the transmitter 506 (T3) to the receiver 428 (R2) is approximately the same as the ratio 433 (e.g., 0.5), and may be approximated by the point 384 (A) on the curve 362 of the graph 360 in reference to FIG. 6. As shown in the graph 360, the apparent resistivity error corresponding to point 384 is between 0.06 and 0.08.

In the illustrated embodiment, a ratio 516 of a length dimension 518 (i.e., L1′″) from the offset transmitter 504 (e.g., T4) to the receiver 430 (R1) to a length dimension 520 (i.e., L2′″) from the transmitter 504 (T4) to the receiver 428 (R2) is less than the ratio 433, and may be approximated by the point 382 (C) on the curve 362 of the graph 360 in reference to FIG. 6. As shown in the graph 360, the apparent resistivity error corresponding to point 382 is significantly higher (e.g., between 0.16 and 0.20) due to an increase in the quantization error δV_{q}, which may be attributed to the ratio 516 of L1′″ to L2′″ being low, thereby resulting in increased spreading loss between the signals.

FIG. 10 illustrates an embodiment of the drill string 105 of the drilling system 100 having the asymmetrical sensor arrangement 500 having an offset receiver 540 and the offset transmitter 506. As shown, the offset transmitter 504 shown in FIG. 9 has been replaced with the offset receiver 540. As discussed herein, it may be appreciated that replacing the offset transmitter 504 with the offset receiver 540 may improve (e.g., decrease) the apparent resistivity error of the measured signal. Due to the asymmetry of the sensor arrangement 500, the sensor gains are not canceled out due to symmetry. To compensate for the asymmetry of the sensors, the sensor responses may be compensated based on the following equation:

$$\frac{{V}_{13}}{{V}_{23}} \sqrt{\frac{{V}_{22}}{{V}_{11}} \frac{{V}_{21}}{{V}_{12}}} = \frac{{Z}_{13}}{{Z}_{23}} \sqrt{\frac{{Z}_{22}}{{Z}_{11}} \frac{{Z}_{21}}{{Z}_{12}}}$$

In the above equation, V₁₁ is the sensor response (e.g., measured voltage) received from T1 on R1, V₁₂ is the sensor response (e.g., measured voltage) received from T1 on R2, V₁₃ is the sensor response (e.g., measured voltage) received from T1 on R3, V₂₁ is the sensor response (e.g., measured voltage) received from T2 on R1, V₂₂ is the sensor response (e.g., measured voltage) received from T2 on R2, V₂₃ is the sensor response (e.g., measured voltage) received from T2 on R3, Z₁₁ is the gain-independent coupling between T1 and R1, Z₁₂ is the is the gain-independent coupling between T1 and R2, Z₁₃ is the gain-independent coupling between T1 and R3, Z₂₁ is the gain-independent coupling between T2 and R1, Z₂₂ is the gain-independent coupling between T2 and R2, and Z₂₃ is the gain-independent coupling between T2 and R3.

In the illustrated embodiment, the sensors 432 are spaced such that the ratio discussed in reference to FIG. 6 remains low. As shown, the ratio 433 of a length dimension 434 (L1) from the transmitter 422 (T1) to the receiver 430 (R1) to the length dimension 436 (L2) from the transmitter 422 (T1) to the receiver 428 (R2) is approximated by the point 384 (A) on the curve 362 of the graph 360 shown in FIG. 6. Because the ratio 433 of L1 to L2 falls within the range of 0.35 to 0.75, the apparent resistivity error is low for the sensors 432 (e.g., between 0.06 and 0.08).

In the illustrated embodiment, the ratio 510 of the length dimension 512 (i.e., L1″) from the offset transmitter 506 (e.g., T3) to the receiver 430 (R1) to the length dimension 514 (i.e., L2″) from the transmitter 506 (T3) to the receiver 428 (R2) is approximately the same as the ratio 433 (e.g., 0.5), and may be approximated by the point 384 (A) on the curve 362 of the graph 360 in reference to FIG. 6. As shown in the graph 360, the apparent resistivity error corresponding to point 384 is between 0.06 and 0.08.

In the illustrated embodiment, a ratio 542 of a length dimension 544 (i.e., L1″″) from the offset receiver 540 (e.g., R3) to the transmitter 422 (T1) to a length dimension 546 (i.e., L2″″) from the receiver 540 (R3) to the transmitter 420 (T2) is slightly greater than the ratio 433, and may be approximated by the point 386 (D) on the curve 362 of the graph 360 in reference to FIG. 6. As shown in the graph 360, the apparent resistivity error corresponding to point 386 is slightly higher than the apparent resistivity error corresponding to point 384, but significantly lower than the apparent resistivity error corresponding to point 382 (C). Because the apparent resistivity error corresponding to the offset receiver 540 is lower as compared to the apparent resistivity error corresponding to the offset transmitter 504 shown in FIG. 9. Therefore, it may be appreciated that by replacing the offset transmitter 504 with the offset receiver 540, the apparent resistivity error of the sensor arrangement 500 may be lowered, thereby improving the accuracy of the received measurements.

In certain embodiments, a computer system (e.g., control system, controller, etc.) of the drilling system 100 may include memory, one or more processors, and instructions stored on the memory and executable by the processor to perform a process, including generating one or more sensor configurations (e.g., sensor configurations as shown in FIGS. 2, 3, and 7-10), evaluating various positions and spacings of transmitters and receivers, ranking the sensor configurations based on one or more parameters (e.g., sensitivity and spreading loss, and selecting or recommending one or more best sensor configurations. The computer system may include a computer model, such as a mathematical model based on the equations and the curve 362 described above, a machine learning model, artificial intelligence, or any combination thereof. The computer model also may be based on historical data and/or sensor measurements at a plurality of geological formations and wellsites, including borehole measurements by sensor configurations similar to those described in detail above. Additionally, the sensor configuration generated by the computer system may be deployed in a downhole tool, which may be used to obtain real-time measurements for use in changing one or more operating parameters of the drilling system 100.

Technical effects of this disclosure include techniques for measuring subterranean geological formations using sensors (e.g., transmitters and receivers) configured to communicate electromagnetic signals. The placement of the transmitters and receivers along the drill string enables the controller to compensate a first signal based on a second signal to concurrently lessen spreading loss of the signal and augment sensitivity of the signal to changes in the formation. Accordingly, by improving both the sensitivity and the spreading loss of the signal, more accurate measurements may be taken of the surrounding formation, thereby enabling more precise steering of the drill string via a rotary steering system. By placing one of the transmitters close to the drill bit allows for earlier detection of nearby bed boundary locations and bed resistivities for geosteering applications. Additional technical effects include generation and use of a computer model (e.g., mathematical model, machine learning model, and/or artificial intelligence) for selecting sensor spacings and/or sensor configurations that result in lower apparent resistivity errors, thereby improving the accuracy and reliability of the measured responses received from the sensors.

The subject matter described in detail above may be defined by one or more clauses, as set forth below.

According to a first aspect, a system includes a drilling system. The drilling system includes a tool string, a bottom hole assembly coupled to a downhole end of the tool string, and a plurality of sensors disposed along the tool string and the bottom hole assembly. The plurality of sensors includes a first sensor disposed proximate to a drill bit of the tool string. The first sensor includes a first transmitter or a first receiver. The plurality of sensors also includes a plurality of second sensors axially offset away from the first sensor further away from the drill bit. The first sensor is configured to communicate with at least a portion of the plurality of second sensors, and the plurality of second sensors includes a nested arrangement of second transmitters and second receivers. The drilling system also includes a controller having a memory and a processor. The controller is configured to receive a plurality of signals from the first sensor or the plurality of second sensors. The controller is also configured to combine the plurality of signals to compensate a transmitter gain and a receiver gain of at least some sensors of the plurality of sensors.

The system of the preceding clause, wherein the first sensor includes the first transmitter.

The system of any preceding clause, wherein the first transmitter is configured to transmit first signals to each of the second receivers in the nested arrangement, and the second transmitters are configured to transmit second signals to each of the second receivers.

The system of any preceding clause, wherein the nested arrangement includes at least two of the second transmitters disposed axially between at least two of the second receivers.

The system of any preceding clause, wherein the nested arrangement includes an axial sequence extending in a direction away from the first sensor, and the axial sequence includes a first one of the second receivers, a first one of the second transmitters, a second one of the second transmitters, and a second one of the second receivers.

The system of any preceding clause, wherein the nested arrangement includes an axial sequence extending in a direction away from the first sensor, and the axial sequence includes a first one of the second receivers, a first one of the second transmitters, a second one of the second transmitters, a second one of the second receivers, and a third one of the second receivers.

The system of any preceding clause, wherein the first sensor includes the first transmitter, the first sensor is axially offset from a first one of the second receivers by a first distance, the first sensor is axially offset from a second one of the second receivers by a second distance, and a ratio between the first distance and the second distance is between 0.4 and 0.7.

The system of any preceding clause, wherein the first sensor includes the first receiver, the first sensor is axially offset from a first one of the second transmitters by a first distance, the first sensor is axially offset from a second one of the second transmitters by a second distance, and a ratio between the first distance and the second distance is between 0.4 and 0.7.

The system of any preceding clause, wherein at least one of the first sensor, the plurality of second sensors, or a combination thereof, includes: a low frequency saddle coil circumferentially disposed about a central axis of the tool string; a high frequency saddle coil circumscribed by the low frequency saddle coil; first and second low frequency axial coils circumferentially disposed about the central axis of the tool string; and first and second high frequency axial coils circumferentially disposed about the central axis of the tool string.

The system of any preceding clause, wherein the first low frequency axial coil and the first high frequency axial coil are disposed in an uphole direction of the low frequency saddle coil and the high frequency saddle coil, and the second low frequency axial coil and the second high frequency axial coil are disposed in a downhole direction of the low frequency saddle coil and the high frequency saddle coil.

The system of any preceding clause, wherein the controller is configured to combine the plurality of signals to compensate a respective gain of each sensor of the plurality of sensors.

According to a second aspect, a system includes a measurement system including a plurality of sensors configured to couple to a drill string. The plurality of sensors includes a first sensor including a first transmitter, and a plurality of second sensors axially offset away from the first sensor. The plurality of second sensors includes a nested arrangement of receivers and second transmitters. The system also includes a controller having a processor, a memory, and instructions stored on the memory and executable by the processor to transmit signals from the first transmitter to each of the receivers in the nested arrangement. The instructions also cause the processor to transmit signals from the second transmitters to each of the receivers. The instructions also cause the processor to receive a plurality of signals from the first sensor or the plurality of second sensors. The instructions also cause the processor to combine the plurality of signals to compensate a transmitter gain and a receiver gain of at least some sensors of the plurality of sensors.

The system of the preceding clause, wherein the nested arrangement includes at least two of the second transmitters disposed axially between at least two of the receivers.

The system of any preceding clause, wherein the nested arrangement includes an axial sequence extending in a direction away from the first sensor, and the axial sequence includes a first one of the receivers, a first one of the second transmitters, a second one of the second transmitters, and a second one of the receivers.

The system of any preceding clause, wherein the nested arrangement includes an axial sequence extending in a direction away from the first sensor, and the axial sequence includes a first one of the receivers, a first one of the second transmitters, a second one of the second transmitters, a second one of the receivers, and a third one of the receivers.

The system of any preceding clause, wherein the nested arrangement of the second transmitters and the receivers extends over an axial range, the first sensor is axially offset from a midpoint of the axial range by a first distance, a second distance extends from the midpoint to a downhole end of the axial range, a second distance extends from the midpoint to an uphole end of the axial range, and the first distance is greater than each of the second and third distances.

The system of any preceding clause, wherein the first transmitter is axially offset from a first one of the receivers by a first distance, the first transmitter is axially offset from a second one of the receivers by a second distance, and a ratio between the first distance and the second distance is between 0.4 and 0.7.

The system of any preceding clause, wherein the ratio between the first distance and the second distance is between 0.45 and 0.55.

According to a third aspect, a method, includes deploying a measurement system including a plurality of sensors into a wellbore via a drill string. The plurality of sensors includes a first sensor having a first transmitter and a plurality of second sensors axially offset away from the first sensor. The plurality of second sensors includes a nested arrangement of receivers and second transmitters. The method also includes transmitting signals from the first transmitter to each of the receivers in the nested arrangement. The method also includes transmitting signals from the second transmitters to each of the receivers. The method also includes receiving a plurality of signals from the first sensor or the plurality of second sensors. The method also includes combining the plurality of signals to compensate a transmitter gain and a receiver gain of at least some sensors of the plurality of sensors. The method also includes obtaining measurements of a geological formation based on the signals, the compensated transmitter gain, the compensated receiver gain, or a combination thereof. The method also includes controlling one or more drilling parameters of a drilling system based on the measurements.

The method of the preceding clause, including combining the plurality of signals to compensate a respective gain of each sensor of the plurality of sensors.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a drilling system, comprising:
a tool string;
a bottom hole assembly coupled to a downhole end of the tool string; and
a plurality of sensors disposed along the tool string and the bottom hole assembly, wherein the plurality of sensors comprises:
a first sensor disposed proximate to a drill bit of the tool string, wherein the first sensor comprises a first transmitter or a first receiver; and
a plurality of second sensors axially offset away from the first sensor further away from the drill bit, wherein the first sensor is configured to communicate with at least a portion of the plurality of second sensors, and the plurality of second sensors comprises a nested arrangement of second transmitters and second receivers; and
a controller comprising a memory and a processor, wherein the controller is configured to:
receive a plurality of signals from the first sensor or the plurality of second sensors; and
combine the plurality of signals to compensate a transmitter gain and a receiver gain of at least some sensors of the plurality of sensors.

2. The system of claim 1, wherein the first sensor comprises the first transmitter.

3. The system of claim 2, wherein the first transmitter is configured to transmit first signals to each of the second receivers in the nested arrangement, and the second transmitters are configured to transmit second signals to each of the second receivers.

4. The system of claim 1, wherein the nested arrangement comprises at least two of the second transmitters disposed axially between at least two of the second receivers.

5. The system of claim 4, wherein the nested arrangement comprises an axial sequence extending in a direction away from the first sensor, and the axial sequence comprises a first one of the second receivers, a first one of the second transmitters, a second one of the second transmitters, and a second one of the second receivers.

6. The system of claim 4, wherein the nested arrangement comprises an axial sequence extending in a direction away from the first sensor, and the axial sequence comprises a first one of the second receivers, a first one of the second transmitters, a second one of the second transmitters, a second one of the second receivers, and a third one of the second receivers.

7. The system of claim 4, wherein the first sensor comprises the first transmitter, the first sensor is axially offset from a first one of the second receivers by a first distance, the first sensor is axially offset from a second one of the second receivers by a second distance, and a ratio between the first distance and the second distance is between 0.4 and 0.7.

8. The system of claim 4, wherein the first sensor comprises the first receiver, the first sensor is axially offset from a first one of the second transmitters by a first distance, the first sensor is axially offset from a second one of the second transmitters by a second distance, and a ratio between the first distance and the second distance is between 0.4 and 0.7.

9. The system of claim 1, wherein at least one of the first sensor, the plurality of second sensors, or a combination thereof, comprises:
a low frequency saddle coil circumferentially disposed about a central axis of the tool string;
a high frequency saddle coil circumscribed by the low frequency saddle coil;
first and second low frequency axial coils circumferentially disposed about the central axis of the tool string; and
first and second high frequency axial coils circumferentially disposed about the central axis of the tool string.

10. The system of claim 9, wherein the first low frequency axial coil and the first high frequency axial coil are disposed in an uphole direction of the low frequency saddle coil and the high frequency saddle coil, and the second low frequency axial coil and the second high frequency axial coil are disposed in a downhole direction of the low frequency saddle coil and the high frequency saddle coil.

11. The system of claim 1, wherein the controller is configured to combine the plurality of signals to compensate a respective gain of each sensor of the plurality of sensors.

12. A system, comprising:
a measurement system comprising a plurality of sensors configured to couple to a drill string, wherein the plurality of sensors comprises:
a first sensor comprising a first transmitter; and
a plurality of second sensors axially offset away from the first sensor, and the plurality of second sensors comprises a nested arrangement of receivers and second transmitters; and
a controller having a processor, a memory, and instructions stored on the memory and executable by the processor to:
transmit signals from the first transmitter to each of the receivers in the nested arrangement;
transmit signals from the second transmitters to each of the receivers;
receive a plurality of signals from the first sensor or the plurality of second sensors; and
combine the plurality of signals to compensate a transmitter gain and a receiver gain of at least some sensors of the plurality of sensors.

13. The system of claim 12, wherein the nested arrangement comprises at least two of the second transmitters disposed axially between at least two of the receivers.

14. The system of claim 13, wherein the nested arrangement comprises an axial sequence extending in a direction away from the first sensor, and the axial sequence comprises a first one of the receivers, a first one of the second transmitters, a second one of the second transmitters, and a second one of the receivers.

15. The system of claim 13, wherein the nested arrangement comprises an axial sequence extending in a direction away from the first sensor, and the axial sequence comprises a first one of the receivers, a first one of the second transmitters, a second one of the second transmitters, a second one of the receivers, and a third one of the receivers.

16. The system of claim 15, wherein the nested arrangement of the second transmitters and the receivers extends over an axial range, the first sensor is axially offset from a midpoint of the axial range by a first distance, a second distance extends from the midpoint to a downhole end of the axial range, a second distance extends from the midpoint to an uphole end of the axial range, and the first distance is greater than each of the second and third distances.

17. The system of claim 13, wherein the first transmitter is axially offset from a first one of the receivers by a first distance, the first transmitter is axially offset from a second one of the receivers by a second distance, and a ratio between the first distance and the second distance is between 0.4 and 0.7.

18. The system of claim 17, wherein the ratio between the first distance and the second distance is between 0.45 and 0.55.

19. A method, comprising:
deploying a measurement system comprising a plurality of sensors into a wellbore via a drill string, wherein the plurality of sensors comprises a first sensor comprising a first transmitter and a plurality of second sensors axially offset away from the first sensor, wherein the plurality of second sensors comprises a nested arrangement of receivers and second transmitters; and
transmitting signals from the first transmitter to each of the receivers in the nested arrangement;
transmitting signals from the second transmitters to each of the receivers;
receiving a plurality of signals from the first sensor or the plurality of second sensors;
combining the plurality of signals to compensate a transmitter gain and a receiver gain of at least some sensors of the plurality of sensors;
obtaining measurements of a geological formation based on the signals, the compensated transmitter gain, the compensated receiver gain, or a combination thereof; and
controlling one or more drilling parameters of a drilling system based on the measurements.

20. The method of claim 19, comprising combining the plurality of signals to compensate a respective gain of each sensor of the plurality of sensors.
